(19) United States
(12) Patent Application Publication
(10) Pub. No.: US 2018/0144126 A1
(43) Pub. Date: May 24, 2018

(54) TASK PERFORMANCE

(71) Applicant: SAP SE, Walldorf (DE)

(72) Inventors: Tillman Swinke, Osthofen (DE); Marc Ziegler, Mauer (DE)

(21) Appl. No.: 15/355,976

(22) Filed: Nov. 18, 2016

(51) Int. Cl. G06F 21/55; G06N 99/00; G06N 5/04

(52) U.S. Cl. CPC G06F 21/554; G06F 2221/032; G06N 5/047; G06N 99/005

(57) ABSTRACT

A computer-implemented method for assisting a user perform a task in a computer system includes deploying a bot to monitor user interactions with the computer system and using machine learning to recognize a pattern in a user's actions in repetitively performing the task in the computer system. The method includes processing the recognized pattern to automatically establish a suggested rule that can be used by the computer system for performing a future instance of the task in lieu of the user performing the future instance of the task.

### BACKGROUND

Computer systems including computing devices (e.g., desktop computers, laptop computers, computers, smart phones, etc.) and computer software or programs are widely used to perform “computerized” tasks (e.g., sending an e-mail or notification, approving an order or purchase, etc.). A computing device-user interface (UI) can include different solutions (e.g., a command line, a graphical user interface (GUI), voice, chats, etc.) for users to interact with a computer system to perform the computerized tasks.

The computerized tasks performed using the computer system may be of a repetitive nature (e.g., sending an e-mail or notification, approving an order or purchase, etc.). However, in current software (e.g., enterprise software), each computerized task (sending an e-mail or notification, approving an order or purchase, etc.) often has to individually set up or initiated by the user. The user may have to manually collect or look up data (e.g., by navigating to other data sources or applications) for each individual computerized task, and make decisions to properly set up or initiate the individual computerized task. This often can be tedious or laborious.

Consideration is now to ways of assisting a user to perform computerized tasks efficiently, for example, by automating at least some of the manual aspects of setting up or initiating the individual computerized task or by suggesting solutions based on previously setup rules.

### SUMMARY

In a general aspect, a computer system includes a server and a bot or agent deployed on the server to monitor user interactions with the computer system. The bot is configured to recognize a pattern in a user's actions in repetitively performing a task in the computer system over a time interval and to process the recognized pattern to automatically establish a suggested rule that can be used by the computer system for automatically performing a future instance of the task in lieu of the user performing the future instance of the task. The bot uses machine learning to recognize the pattern in the user's actions.

In another aspect, the bot presents the suggested rule to the user and receives user input on the acceptability of the suggested rule as a rule that can be used by the computer system for automatically performing the future instance of the task. Based on the user's input, the bot designates the suggested rule as a confirmed rule that can be used by the computer system for automatically performing the future instance of the task.

In a further aspect, the bot causes the computer system to automatically perform the future instance of the task using the confirmed rule. The bot may notify the user of the confirmed rule before the computer system actually performs the future instance of the task, and, based on user input, modify or refine the confirmed rule before actually performing the future instance of the task.

The details of one or more implementations are set forth in the accompanying drawings and the description below. Further features of the disclosed subject matter, its nature and various advantages will be more apparent from the accompanying drawings, the following detailed description, and the claims.

### BRIEF DESCRIPTION OF THE DRAWINGS

FIG. 1 is a block diagram illustration of an example system computer system, which includes a software agent or bot configured to generate rules or suggestions to assist users in performing tasks in the computer system, in accordance with the principles of the present disclosure.

FIG. 2 is a schematic diagram illustrating development of situation-based rules or suggestions by a bot for an individual user's tasks, in accordance with the principles of the present disclosure.

FIG. 3 is an illustration of a dialog between bot and a user before there is a confirmed rule for releasing user's work offers, in accordance with the principles of the present disclosure.

FIG. 4 is an illustration of a dialog between the bot and the user to confirm or refine the suggested rule set up after the dialog of FIG. 3, in accordance with the principles of the present disclosure.

FIG. 5 is an illustration of a dialog between the bot and the user informing the user of an implementation of the confirmed or refined rule of FIG. 4, in accordance with the principles of the present disclosure.

FIG. 6 is a flow chart illustrating an example computer-implemented method for assisting users in performing tasks in a computer system, in accordance with the principles of the present disclosure.

### DETAILED DESCRIPTION

A computer system (including computing devices and computer software or applications) may be deployed in an enterprise or organization for users or workers to perform computerized tasks (e.g. send or respond to e-mails, notifications or messages, process or edit documents, approve an order, run reports, set up meetings, etc.) that may, for example, be involved in the operation of the enterprise or organization.

The computer system may include one or more backend servers, which may host the computer applications that may be used to perform the tasks. The backend servers may be connected to one or more databases, and may be accessible to frontend client computing devices (e.g., desktop computers, smartphones, mobile computing device, watches, apparel devices, etc.) over wired or wireless networks. Users or workers may use the one or more frontend client devices to access the computer software or applications and perform the tasks (e.g., send notifications, approve/deny requests, or forward proposals, etc.). The tasks may, for example, be displayed and executed on respective user interfaces (UIs) of the one or more frontend client devices.

Each user or worker in the enterprise or organization may, for example, be assigned a specific role, which encompasses performing a corresponding set of tasks. This set of tasks may, for example, include tasks of varying complexities and dependencies. A user may utilize the same computer system (possibly using the same or different client devices) over an extended period of time to perform the tasks that he or she is responsible for, or which fall in the scope of his or her role. The individual tasks that the user performs or is expected to perform (e.g., send notifications, approve/deny requests, or forward proposals, etc.) may be repetitive.

The computer system may further include an independent software process or agent (hereinafter “bot”) which creates rules or suggestions that may be implemented by the computer system to assist or help the user's performance of the tasks, in accordance with the principles of the present disclosure. The rules or suggestions may, for example, be directed to automating performance or execution of the user's future tasks (e.g., repetitive tasks).

The bot, which may be hosted on a backend server, may be configured to track incoming system messages on the user's client computing device, and the user's reactions and response to these system messages. The bot may monitor and recognize patterns in the user's performance of his or her tasks, and his or her reactions to system events and messages related to the user's performance of his or her tasks. The bot may also be configured to recognize patterns in the user's general use of the client computing device (e.g., for e-mails and data transfers, etc.), the user's use of other devices (e.g., personal devices such as mobile phones, fitness tracking bands, wearable computers, etc.), or the user's behavior that is not system-related (i.e. not directly related to the user's performance of his or her tasks). The bot may employ machine learning techniques (e.g., neural networks, fuzzy logic, graph theory, or other optimizing algorithms such as simulated annealing, hill climbing, greedy algorithm, genetic algorithm, gradient descent, etc.) for the pattern recognition. An example pattern may, for example, be that the user always sends sales offers to the purchase manager assistants but not to the purchase managers of potential customer organizations. Another example pattern may, for example, be that the user always approves purchase requests of less than 1000 euros without further inquiry or questions.

Based on the recognized patterns, the bot may create rules or suggestions to assist the user's performance of his or her tasks. A rule may, for example, describe how to respond to a system event or message based on a recognized pattern in the user's past responses to the same or similar system events or messages. The rules or suggestions may be a function of different variables, for example, user identity, user role, location, and time, etc. The bot may include or be coupled to a notification/chatting tool, which can be used to notify the user of a proposed rule and get the user's approval (or disapproval) of the proposed rule for future implementation.

The rules or suggestions, which may be implemented by the computer system, may result, for example, in the computer system automating some tasks (fully or partially), combining or merging some tasks, or otherwise preparing, modifying or redesigning the tasks with a view to reduce the user's efforts or interactions required to complete the tasks. Using the rules or suggestions to assist the user's performance of his or her tasks may free the user from doing repetitive or mundane tasks and may allow the user to focus, for example, on complex business decisions. It may be expected that reducing the user's efforts or interactions required to complete the tasks may result in a superior user experience (UX) with the computer system.

The rules or suggestions implemented by the computer system to assist the user's performance of his or her tasks may include the rules created by the bot based on the recognized patterns, and other rules that may have been pre-installed in the computer system. The pre-installed rules may include rules that may have been empirically developed based, for example, on previous knowledge or corporate policies. The pre-installed rules may include rules previously created by the bot. The rules or suggestions implemented by the computer system to assist the user's performance of his or her tasks may include public rules (e.g., corporate policies) applicable to all users, and private rules applicable personally to individual users or individual categories of users (e.g., role, profession, or industry-based categories of users).

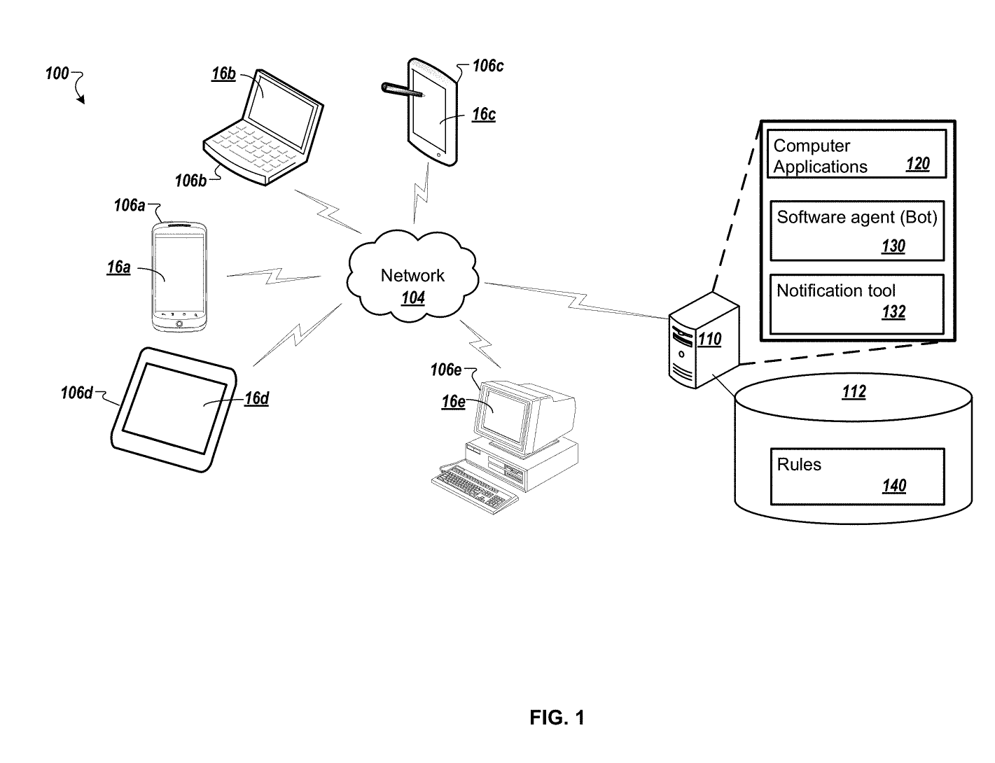

FIG. 1 shows an example implementation of the foregoing computer system (e.g., as computer system 100), which includes a software agent or bot (e.g., bot 130) configured to generate rules or suggestions to assist users in performing tasks in the computer system, in accordance with the principles of the present disclosure. The tasks may relate to operations on, or processing of, objects (e.g., meeting, proposal, order, travel request, client, etc.) of computer applications or software (e.g., computer applications 120) hosted in the computer system. Example tasks may, for example, include approving or disapproving an order, submitting a proposal, accepting a meeting invite, etc.

Computer system 100 may include one or more backend servers (e.g., server 110), which may be connected to one or more databases (e.g., database 112). Server 110 may be connected to one or more client computing devices (e.g., client computing devices 106a-e) over a communication network (e.g., network 104).

In an example implementation, client computing device 106a may, for example, be a mobile phone, a smartphone, a personal digital assistant, or other type of mobile computing device; client computing device 106b may, for example, be a laptop or notebook computer. client computing device 106c may, for example, be a tablet computer; client computing device 106d may, for example, be a wearable computing device such as a smartwatch; and client computing device 106d may, for example, be a desktop computer. Client computing devices 106a-e may include respective displays (e.g., displays 16a-e), which may display front end user interfaces (UI) of the computer applications (e.g., computer applications 120) used for performing the tasks.

In some implementations, network 204 (which links the one or more backend servers (e.g., server 110) and the one or more client computing devices (e.g., client computing devices 106a-e)) can be a public communications network (e.g., the Internet, a cellular data network, a dialup modem connection over a telephone network, etc.) or a private communications network (e.g., a private LAN, a leased line, etc.). In some implementations, computing devices 206a-e can communicate with the network 204 using one or more high-speed wired and/or wireless communications protocols (e.g., IEEE 802.11 or variations, WiFi, Bluetooth, Transmission Control Protocol/Internet Protocol (TCP/IP), Ethernet, IEEE 802.3, etc.).

In computer system 100, the backend servers (e.g., server 110) may host the computer software or applications (e.g., computer applications 120) used for performing the tasks. Computer applications 120 may include one or more of any type of computer applications (e.g., word processing software, database software, spreadsheet software, presentation software, multimedia software, enterprise software, information worker software, simulation software, educational software, content access software, product engineering software, etc.).

Server 110 may further host a software agent (e.g., bot 130) which may be configured to recognize patterns in how users perform or execute tasks on the one or more client computing devices (e.g., client computing devices 106a-e). Bot 130 may further process the recognized patterns to generate rules or suggestions (e.g., rules 140) for performing one or more of the tasks for one or more of the users. In some implementations, bot 130 may also retrieve rules, which may have been previously generated or pre-installed from memory. Bot 130 may include a notification or chat tool (e.g. notification tool 132) for communicating with a user of any of the one or more client computing devices (e.g., client computing devices 106a-e).

While the backend servers in computer system 100 are visually represented in FIG. 1, for example, by a single server (i.e. server 112) for visual clarity, it will be understood that the backend servers in computer system 100 may include any number of servers (e.g., a web management server, a frontend server, a backend server, a mobile device management server, an e-mail server, a database management server, etc.) that may be used, for example, by an enterprise to provide information technology and computing services to users of the one or more client devices client computing devices (e.g., client computing devices 106a-e). Though not specifically shown in FIG. 1, each of the backend servers in computer system 100 can include one or more processors (e.g., semiconductor-based processors) and one or more memory devices. Each server can run (execute) a server operating system.

Bot 130 may be configured to monitor user interactions with one or more of the backend servers in computer system 100 to recognize computer usage patterns and habits of users that may be related to how the users perform or execute tasks on the one or more client computing devices (e.g., client computing devices 106a-e). A task may involve action on a particular application object. Bot 130 may receive, pull, or retrieve information related to the particular application object/task and also information related to other applications or application objects that mat be relevant to, or needed for, the user's performance of the task. Bot 130 may be configured to receive, pull, or retrieve information that may be related to how the users perform or execute tasks on the one or more client computing devices (e.g., client computing devices 106a-e) from any of a number of different sources including, for example, Microsoft Exchange, Microsoft Lync, messaging facilities (e.g., SMS, MMS, IM, etc.), social media platforms and apps (e.g., Amazon Alexa), internal and/or external enterprise systems, web sites, geolocation services, etc.

Bot 130 may be configured to recognize patterns in how each individual user performs one or more of the tasks by using machine learning techniques (e.g., neural network algorithms, fuzzy logic, etc.) to process information gathered by monitoring the user interactions with the computer system and or the other information on the individual user's computer usage, behavior, and habits that bot 130 may have collected from the different sources.

Bot 130 may be configured to develop rules or suggestions for each individual user for performing or executing his or her tasks based on the recognized computer usage patterns of the individual user in conjunction with situations and circumstantial factors of the individual user. Bot 130 may develop the rules or suggestions for the individual users as meta rules for identity- or role-based categories of users (e.g., a meta rule for all managers in a company, or a meta rule for all accountants across companies, etc.).

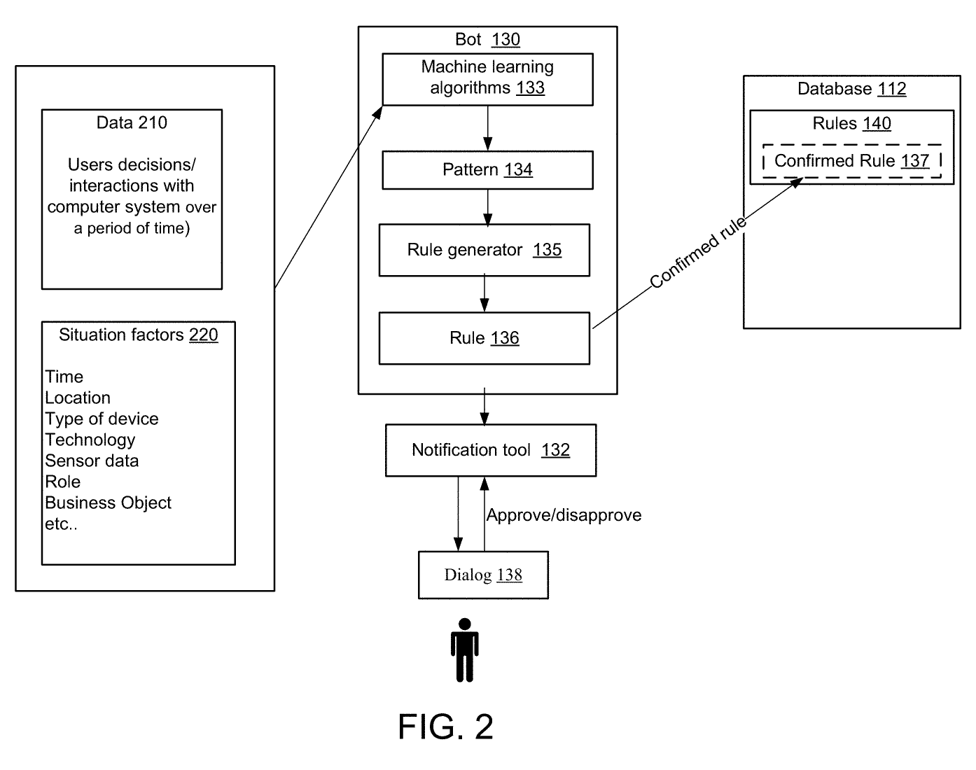

FIG. 2 is a block diagram which schematically illustrates development or generation of situation-based rules or suggestions by bot 130 for an individual user's tasks, in accordance with the principles of the present disclosure. A situation or circumstance in the context of the individual user's use of computer system 100 to perform tasks may be defined by situation factors (e.g., situation factors 220) Situation factors 220 may, for example, include information one or more factors such as Time (e.g., daytime, season, day of the week, month, etc.); Location (e.g., Office, Home, Customer site, Country, etc.); Type of Device (e.g., desktop, phone, watch, apparel computing device, etc.); Communication Technology (e.g., Bluetooth, WiFi, NFC, tracking in Fiori, etc.); Sensor data (e.g., Gyroscope, Barometer, Temperature, 3D-Touch, etc.); Role (e.g., manager; executive, employee, designer, developer, etc.); and Business Object of task (e.g., meeting, proposal, order, request, meeting invite, e-mail, client, etc.). Information on the situation factors may be gleaned not only from the computer system (e.g., computer system 100) used for performing the tasks but also from other systems (e.g., Chat, chatBOT, SMS, Phone, Email, natural language user interfaces, etc.) that may be used by the users for communications between applications.

As shown in FIG. 2, bot 130, may receive, collect or retrieve information (e.g., data 210) on users decisions/interactions with computer system over a period of time and information (e.g., situation factors 220) on the situations relating to the individual user's use of computing system 100 to perform the tasks. Situation factors 22 may include given general rules (e.g. company policies) for performing the tasks. A machine learning algorithm 133 in bot 130 may process the foregoing information (e.g., data 210 and situation factors 220) to determine if a pattern of user actions and situations in performing a task (e.g., a pattern 134) can be recognized in the data. When pattern 134 is recognized, rule generator 135 in bot 130 may automatically generate a rule or suggestion (e.g., rule 136) for performing or modifying the user's tasks.

Recognizing a pattern of user actions in performing a task (e.g., a pattern 134) in the data presumes that the user repeatedly performs the same task a number of times to generate sufficient data for the pattern to develop and be recognized by machine learning algorithm 133. The first few times the user performs the task may not result in sufficient data for the pattern (e.g., a pattern 134) to develop and be recognized by machine learning algorithm 133. Thus, bot 130 may not generate a rule or suggestion (e.g., rule 136) after these first few times the user performs the task. Even after there is sufficient data for the pattern (e.g., a pattern 134) to develop and be recognized by machine learning algorithm 133, and while being used, bot 130 may continue to collect and process additional data to iteratively refine pattern 134 and rule 136. The additional data may include data related to additional times the user performs the task and also include any feedback or input received from the user regarding a current version of rule 136.

In example implementations, notification tool 132 may present rule 136 (e.g., in a dialog 138 on a user interface of a client computing device) to the individual user as a proposed rule for automating (fully or partially) the performance of one or more of the user's tasks. The user may approve, disapprove or even alter the proposed rule. If the user approves of rule 136 for automating (fully or partially) the performance of the one or more of the user's tasks, bot 130 may store rule 136 (e.g., in rules 140) as a “confirmed” rule (e.g., confirmed rule 137) so that computer system 100 can later on use confirmed rule 137 to automate (fully or partially) the performance of the one or more of the user's tasks. Bot 130 may refine present rule 136 and/or confirmed rule 137 based on user input, which may be received, for example, via dialog 138.

Rule 136 may be defined by rule generator 135 only for the particular set of values of variables (e.g., user identity, Time, Location, Type of Device, Communication Technology, Sensor data, Role, Business Object, etc.) of the individual user's tasks for which pattern 134 was recognized. For example, rule 136 may be defined by rule generator 135 for Role value=manager. Rule 136 may also be defined by rule generator 135 as a “fuzzy” rule. Instead of only matching or not matching, the rule variables can also, for example, match to a value between 0 and 1 (e.g. 0.4). In some implementations of computer system 100, already acquired patterns (e.g., pattern 134) and rules (e.g., rule 136) for different individual users at different times or situations may be aggregated (e.g., over one or more of the variables) to create a general rule applicable to the remaining common variables. For example, rules (e.g., rule 136) for different individual users may be aggregated to create a general rule for a common role (e.g., role=executive) of the different individuals.

The general rules (including, e.g., a rule for a user role) may be included in future system versions computer system 100 as a standard-set of rules or suggestions. The standard set of rules may only need to be refined for a new individual user by bot 130 when developing rules for the new individual user's tasks.

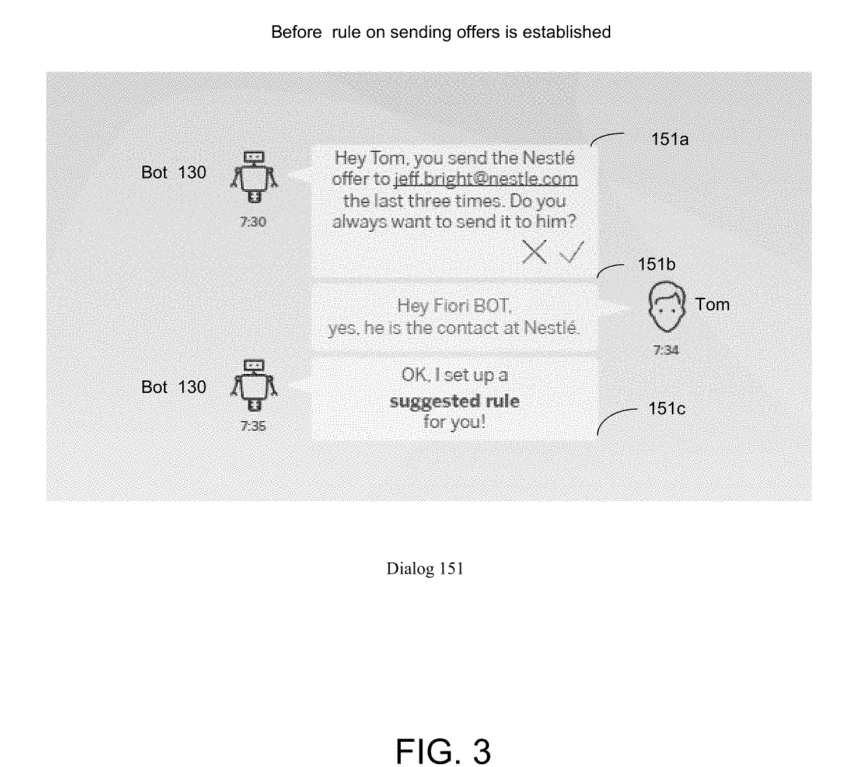

It may be expected that the use of the machine-learnt rules to automatically perform the user's tasks (in conjunction with the use of user input and feedback to bot 130 for dynamically refining the rules) will substantially improve user experience (UX) with computer system 100. FIG. 3-6 illustrate, for example, user experience (UX) with the rules being dynamically refined in response to user input to bot 130 for an example customer meeting situation. The user input may be received, for example, via dialogs 151-153 presented on the user's client computing device by notification tool 132.

### Customer Meeting Situation

A customer meeting situation may, for example, relate to a meeting that a user “Tom” has with a customer company (e.g., Nestle) to present a work offer (e.g., installation of hardware). The customer meeting situation may, for example, correspond to situation factors 220 as follows: User-identity (Tom), Time (daytime), Type of Device (phone), Communication Technology (tracking in Fiori), Sensor Data (NA); Role (manager); and Business Object (meeting).

In this customer meeting situation, bot 130 may have learnt from user Tom's calendar that that a customer meeting has been scheduled and that Tom intends to release or send a work offer so that it can be discussed at the meeting.

FIG. 3 shows an example dialog 151 between bot 130 and user (Tom), before there is an existing rule for releasing Tom's work offers, in accordance with the principles of the present disclosure Bot 130 may recognize that there is a pattern (e.g., pattern 134) in how Tom sends or releases work offers to the customer. In dialog 151, bot 130 (at 151a) may inform Tom of the pattern as follows “Hey, Tom, you send the Nestle offers to jeffbright at nestle.com the last three times. Do you always want to send it to him?” Tom (at 151b) may respond as follows: “Hey Fiori Bot, yes, he is the contact at Nestle.” In response, bot 130 may establish a rule (e.g., rule 136) based on the recognized pattern and respond to Tom (at 151c) as follows: “OK, I set up a suggested rule for you.” The suggested rule being always send Tom's Nestle offers to jeff.bright at nestle.com.

Bot 130/computer system 100 may prepare to automatically send all Nestle offers released by Tom to jeff.bright at nestle.com according to the suggested rule of dialog 151. However, before actually implementing the suggested rule, bot 130/computer system 100 may be configured to confirm or refine the rule based on user feedback.

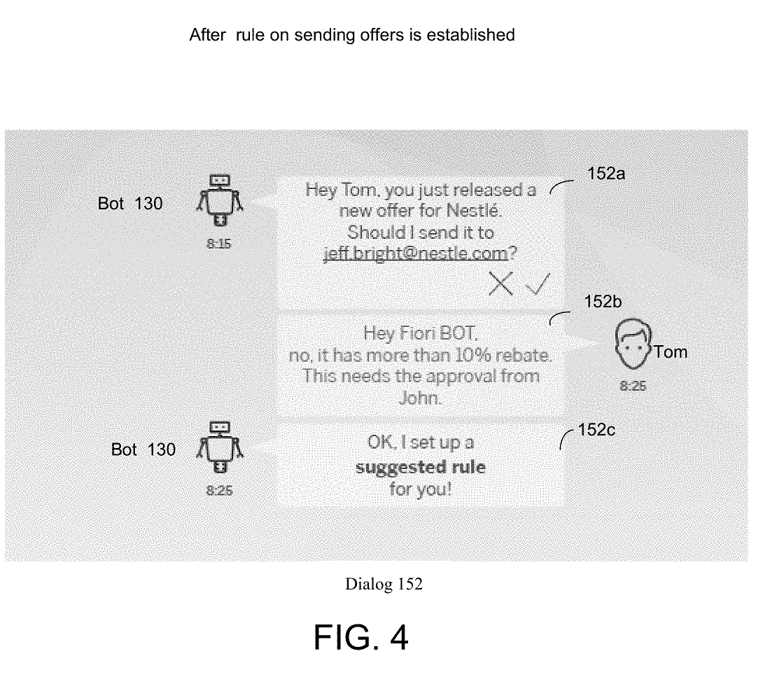

FIG. 4 shows an example dialog 152 between bot 130 and Tom to confirm or refine the suggested rule set up after dialog 151, in accordance with the principles of the present disclosure.

To confirm the rule, bot 130 in dialog 152 may inform Tom (at 152a) as follows “Hey Tom, you just released a new offer for Nestle. Should I send it to jeff.bright at nestle.com?” Tom may respond (at 152b) as follows: “Hey Fiori Bot, No, it has more than 10% rebate. This needs approval from John”.

In response to Tom's clarification at 152b, bot 130 may modify the user tasks and confirm the suggested rule so that any offer released by Tom with more than 10% rebate is automatically first sent to John for approval as a preliminary task before the task of sending the offer to jeffbright at nestle.com. Bot 130 in dialog 152 (at 152c) may inform Tom of the modified user tasks and confirmed rule as follows: “OK, I set up a suggested rule for you!”

Bot 130/computer system 100 may implement the confirmed or refined rule (of dialog 152), with out further intervention by Tom, for example, by automatically sending the Nestle offer to John for approval, and once approved by John, sending the approved offer to jeffbright at nestle.com.

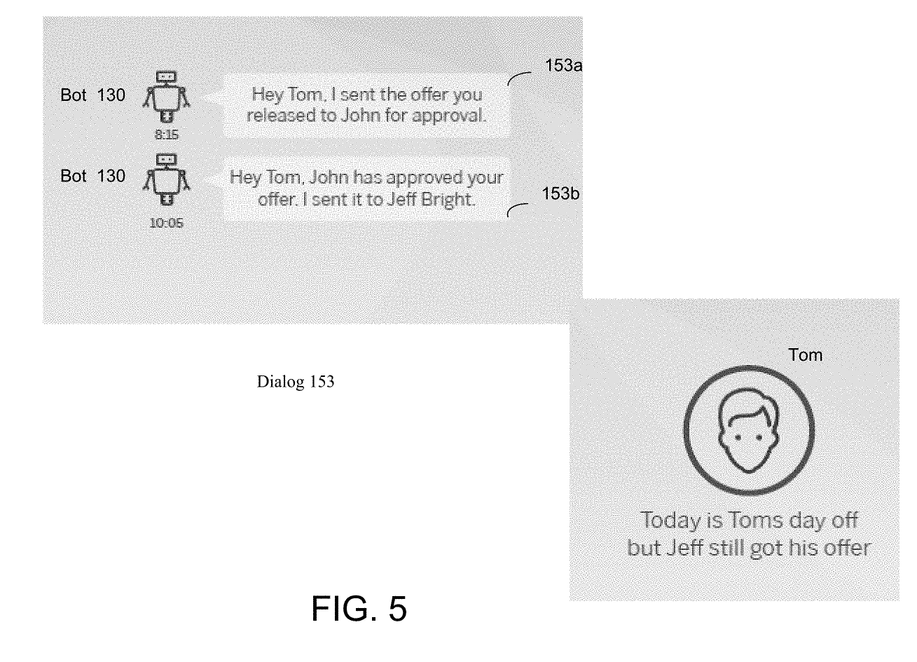

FIG. 5 shows an example dialog 153 between bot 130 and Tom informing Tom of the actions taken by bot 130/computer system 100 of the implementation of the confirmed or refined rule of FIG. 4, in accordance with the principles of the present disclosure. Example dialog 153 may be used, for example, only in scenarios that involve fully automated tasks.

Bot 130 may inform Tom in dialog 153 of the automated completion of the tasks as follows: (at 153a) “Hey Tom, I just sent the offer you released to John for approval,” and (at 153b) “Hey Tom, John has approved your offer. I sent it to Jeff Bright.”

Bot 130 by automatically preforming user tasks, which otherwise would require repetitive efforts by the users, improves user experience in interacting with computer system 100. In the foregoing example of FIG. 5, bot 130 by automatically sending Tom's Nestle offer to the two parties (e.g., John and jeff.bright at nestle.com designated in the confirmed rule of dialog 152) frees Tom from having to do the chores himself and allows Tom to attend to other matters that may be more valuable to him or the enterprise, or attend to more complex matters that are not handled by the system.

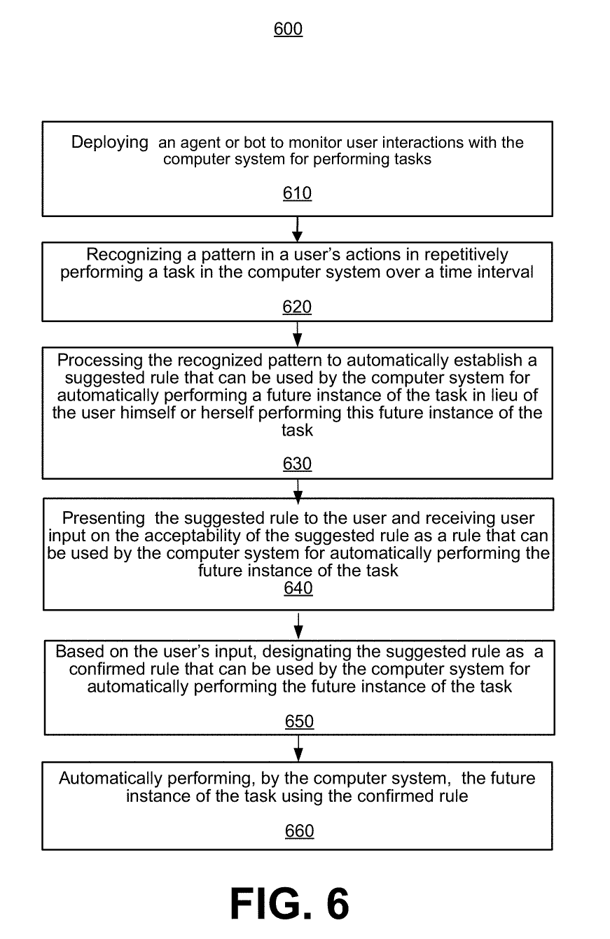

FIG. 6 is a flow chart illustrating an example computer-implemented method 600 for assisting users in performing tasks in a computer system, in accordance with the principles of the present disclosure. The tasks may, for example, include tasks such as sending or responding to e-mails, notifications or messages, processing or editing documents, approving an order, running reports, setting up meetings, etc. These tasks, which may be repetitive or mundane, may be performed by action on objects (e.g., meeting, proposal, order, travel request, client, etc.) of computer applications or software hosted in the computer system. The computer system may include servers and databases hosting the computer applications or software. Users may access these computer applications or software, for example, via client computer devices that are wirelessly or wire connected to the servers and databases.

Method 600 includes deploying an agent or bot (or making use of already existing system components) to monitor user interactions with the computer system for performing tasks in the computer system (610), and recognizing a pattern in a user's actions in repetitively performing a task in the computer system over a time interval (620).

Deploying a bot to monitor user interactions with the computer system 610 may include determining the user's computer usage habits and contexts for the user's actions in performing the task.

Method 600 further includes processing the recognized pattern to automatically establish a suggested rule that can be used by the computer system for automatically performing a future instance of the task in lieu of the user himself or herself performing this future instance of the task (630).

Method 800 may include presenting the suggested rule to the user and receiving user input on the acceptability of the suggested rule as a rule that can be used by the computer system for automatically performing the future instance of the task (640) and, based on the user input, confirming the suggested rule as a confirmed rule that can be used by the computer system for automatically performing the future instance of the task (650). Further, method 800 may include automatically performing, by the computer system, the future instance of the task using the confirmed rule (660).

Automatically performing the future instance of the task using the confirmed rule 660 may include notifying the user (e.g., via dialog 138) of the confirmed rule before actually performing the future instance of the task, and then, based on the user's response, modifying the confirmed rule or task if needed before actually performing the future instance of the task.

Method 600 may be implemented using “machine learning” computer systems (e.g., computer system 100 described with reference to FIGS. 1 and 2). The computer systems (e.g., computer system 100) may autonomously machine learn from user habits, contexts and histories of task performance and may recognize repetitive patterns in task performance. These machine-learnt patterns may be represented within a rule engine with rules that may be based on various variables (e.g., user identity, role, location, time, etc.). The rules may be dynamic and may be modified or refined based, for example, on user input of feed back. Every time a user actually acts in favor of a rule, it may get stronger, and every time the user disfavors a rule, it may get less strong.

Some of the machine learning pattern and rule variables (e.g., roles, locations) may be interchangeable or common between users. Thus, the computer systems (e.g., computer system 100) may not have to start machine learning from scratch (cold start problem) for a new user, but may have a basic or starting rule set (which may be learnt from other users, for example, having the same role, location, company, or department as the new user) already implemented.

The computer systems (e.g., computer system 100) may act autonomously to resolve tasks, based on rules and previous user decisions, in accordance with the principles of the present disclosure. Different stages of autonomy may be defined. In a complete autonomy mode, the computer systems may fully perform a task, as may be agreed to with the user, based on existing rules and or historic decisions. In a partial autonomy mode, the computer systems may respond to a task, even a task that has never occurred before, with a suggested rule, ready to trigger awaiting user approval. The computer systems may ignore some tasks and respond to other tasks with a regular notification (i.e., without suggest rules). When rules are suggested for tasks, the computer systems may monitor user responses and refine the suggested rules over time. It may be expected that the computer systems with the machine learning capabilities will reach states where the users do not have to interact with the computer systems for many of their tasks as the computer systems will automatically perform these tasks.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors (e.g., semiconductor-based processors) of any kind of digital computers. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer-implemented method for assisting a user perform a task in a computer system, the method including:
deploying a bot to monitor user interactions with the computer system;
recognizing a pattern in a user's actions in repetitively performing the task in the computer system over a time interval; and
processing the recognized pattern to automatically establish a suggested rule that can be used by the computer system for automatically performing a future instance of the task in lieu of the user performing the future instance of the task.

2. The computer-implemented method of claim 1, wherein recognizing a pattern in a user's actions in repetitively performing the task in the computer system over a time interval include using machine learning to recognize the pattern.

3. The computer-implemented method of claim 1 further comprising:
presenting the suggested rule to the user and receiving user input on the acceptability of the suggested rule as a rule that can be used by the computer system for automatically performing the future instance of the task.

4. The computer-implemented method of claim 3 further comprising:
based on the user's input, designating the suggested rule as a confirmed rule that can be used by the computer system for automatically performing the future instance of the task.

5. The computer-implemented method of claim 4 further comprising:
automatically performing, by the computer system, the future instance of the task using the confirmed rule.

6. The computer-implemented method of claim 5, wherein automatically performing, by the computer system, the future instance of the task using the confirmed rule includes notifying the user of the confirmed rule before actually performing the future instance of the task.

7. The computer-implemented method of claim 6, wherein automatically performing, by the computer system, the future instance of the task using the confirmed rule includes modifying or refining the confirmed rule based on user input before actually performing the future instance of the task.

8. A non-transitory computer readable storage medium having instructions stored thereon, including instructions which, when executed by a microprocessor, cause a computer system to:
deploy a bot to monitor user interactions with the computer system;
recognize a pattern in a user's actions in repetitively performing the task in the computer system over a time interval; and
process the recognized pattern to automatically establish a suggested rule that can be used by the computer system for automatically performing a future instance of the task in lieu of the user performing the future instance of the task.

9. The non-transitory computer readable storage medium of claim 8, wherein recognizing a pattern in the user's actions in repetitively performing the task in the computer system over the time interval includes using machine learning to recognize the pattern.

10. The non-transitory computer readable storage medium of claim 8, wherein the instructions which, when executed by a microprocessor, further cause the computer system to present the suggested rule to the user and receive user input on the acceptability of the suggested rule as a rule that can be used by the computer system for automatically performing the future instance of the task.

11. The non-transitory computer readable storage medium of claim 10, wherein the instructions which, when executed by a microprocessor, further cause the computer system to: based on the user's input, designate the suggested rule as a confirmed rule that can be used by the computer system for automatically performing the future instance of the task.

12. The non-transitory computer readable storage medium of claim 11, wherein the instructions which, when executed by a microprocessor, further cause the computer system to automatically perform the future instance of the task using the confirmed rule.

13. The non-transitory computer readable storage medium of claim 12, wherein the instructions which, when executed by a microprocessor, further cause the computer system to notify the user of the confirmed rule before actually performing the future instance of the task.

14. The non-transitory computer readable storage medium of claim 13, wherein the instructions which, when executed by a microprocessor, further cause the computer system to modify or refine the confirmed rule based on user input before actually performing the future instance of the task.

15. A computer system comprising:
a server; and
a bot deployed on the server to monitor user interactions with the computer system,
wherein the bot is configured to recognize a pattern in a user's actions in repetitively performing the task in the computer system over a time interval and
process the recognized pattern to automatically establish a suggested rule that can be used by the computer system for automatically performing a future instance of the task in lieu of the user performing the future instance of the task.

16. The computer system of claim 15, wherein the bot uses machine learning to recognize the pattern in the user's actions.

17. The computer system of claim 15, wherein the bot presents the suggested rule to the user and receives user input on the acceptability of the suggested rule as a rule that can be used by the computer system for automatically performing the future instance of the task.

18. The computer system of claim 17, wherein the bot, based on the user's input, designates the suggested rule as a confirmed rule that can be used by the computer system for automatically performing the future instance of the task.

19. The computer system of claim 18, wherein the bot causes the computer system to automatically perform the future instance of the task using the confirmed rule.

20. The computer system of claim 19, wherein the bot notifies the user of the confirmed rule before actually performing the future instance of the task, and, based on user input, modifies or refines the confirmed rule before actually performing the future instance of the task.
